(19) United States
(12) Patent Application Publication
(10) Pub. No.: US 2003/0141132 A1
(43) Pub. Date: Jul. 31, 2003

(54) Integral over-running load control valve on tractor remote valve section for agricultural loader boom circuit

(76) Inventor: Vladimir M. Kowalyk, Winnipeg (CA)

Correspondence Address: CNH INTELLECTUAL PROPERTY LAW DEPARTMENT, CASE NEW HOLLAND INC., P.O. BOX 1895, MS 641, NEW HOLLAND, PA, 17557, US

(21) Appl. No.: 10/347,952

(22) Filed: Jan. 21, 2003

Related U.S. Application Data
(60) Provisional application No. 60/353,683, filed on Jan. 31, 2002.

(51) Int. Cl. B60K 17/00

(52) U.S. Cl. 180/306

(57) ABSTRACT

These and other features and objects are achieved by providing an over-running load control valve integral with the remote valve section of an agricultural tractor to allow it to efficiently work in a multipurpose agricultural environment. A counterbalance cartridge valve, with reverse flow check, is manifolded to an agricultural remote valve section.

### CROSS-REFERENCE TO RELATED APPLICATIONS

This application claims the benefit of copending U.S. Provisional Application Serial No. 60/353,683, filed Jan. 31, 2002.

### BACKGROUND OF THE INVENTION

The present invention relates generally to hydraulic control valves, and more particularly to such a valve assembly integral to the tractor (not loader) that incorporates a counterbalance cartridge valve, with reverse flow check, manifolded to an agricultural remote valve section for a loader boom circuit of an agricultural tractor.

Currently, agricultural tractor loaders typically do not use any type of zero leak load holding valves and, as a result, if a heavy load is left in a bucket above the ground level, the loader will settle and the load will end up on the ground unless the operator intervenes and raises the load. One solution to this leak down problem is to use a pilot-operated check valve that eliminates leak down; however, a pilot-operated check valve requires a pilot pressure (in a specific ratio to the load holding pressure) to keep it open whenever the load is to be lowered. The preferred specific ratio is 10:1 though other similar ratios would work satisfactorily. If this pilot pressure drops below the critical ratio, the pilot-operated check valve will start to open and close (“chatter”) and the load will become unstable. To correct this, orifices have been put in line ahead of the pilot-operated check valve to build up and maintain pressure on the lowering side and to limit the speed at which the loader will function (limits flow), thus increasing cycle times. Unnecessary heat is also built up as oil is forced through the orifices. Although the pilot-operated check provides zero leak load holding, it compromises the overall loader performance.

Agricultural loaders are required to operate in a broad range of applications in numerous environments. Until now, agricultural loaders have not been optimized, and thus do not exhibit operational characteristics, such as zero leak load holding capabilities, over-running load control, floatation functions, overpressure relief and fast cycle times, significantly compromising their performance in a multipurpose agricultural environment.

It would be quite beneficial to have a tractor integral load control for agricultural tractors that avoids the shortcomings identified above.

### SUMMARY OF THE INVENTION

Accordingly, one object of the present invention is to provide an integral over-running load control valve for agricultural tractors that overcomes the problems and shortcomings of similar prior art devices.

Another object of the present invention is to provide a novel and integral over-running load control valve that has zero leak load holding capabilities.

It is another object of the instant invention to provide an integral over-running load control valve that employs a piloted relief valve that will automatically slow the load as less oil is available on the lower side.

Yet another object of the present invention is to provide an integral load control that will provide smooth and stable control of the load movement at any engine speed or hydraulic flow.

It is yet another object of this invention to provide an improved integral over-running load control valve that will provide better/guaranteed float capabilities.

It is a still further object of the instant invention to provide an improved integral over-running load valve control where, in the float mode, pilot pressure is fed internally to the over-running valve to keep it open, and, because the valve has a pilot ratio of 10:1, maximum loads can be floated using pilot pressure.

It is an even still further object of the instant invention to provide an improved integral over-running load control valve that gives overpressure or thermal relief.

It is a further object of the instant invention to provide an improved integral over-running load control valve with no requirement for orifices, thus improving loader performance greatly as cycle times are much shorter and there is no additional heat build up.

These and other features and objects are achieved by providing an over-running load control valve integral with the remote valve section of an agricultural tractor to allow it to efficiently work in a multipurpose agricultural environment. A counterbalance cartridge valve, with reverse flow check, is manifolded with, or “stacked” with, an agricultural remote valve section.

### DESCRIPTION OF THE DRAWINGS

The advantages of this invention will be apparent upon consideration of the following detailed disclosure of the invention, especially when taken in conjunction with the accompanying drawing wherein:

FIG. 1 is a schematic of the control valve of the instant invention.

### DESCRIPTION OF THE PREFERRED EMBODIMENT

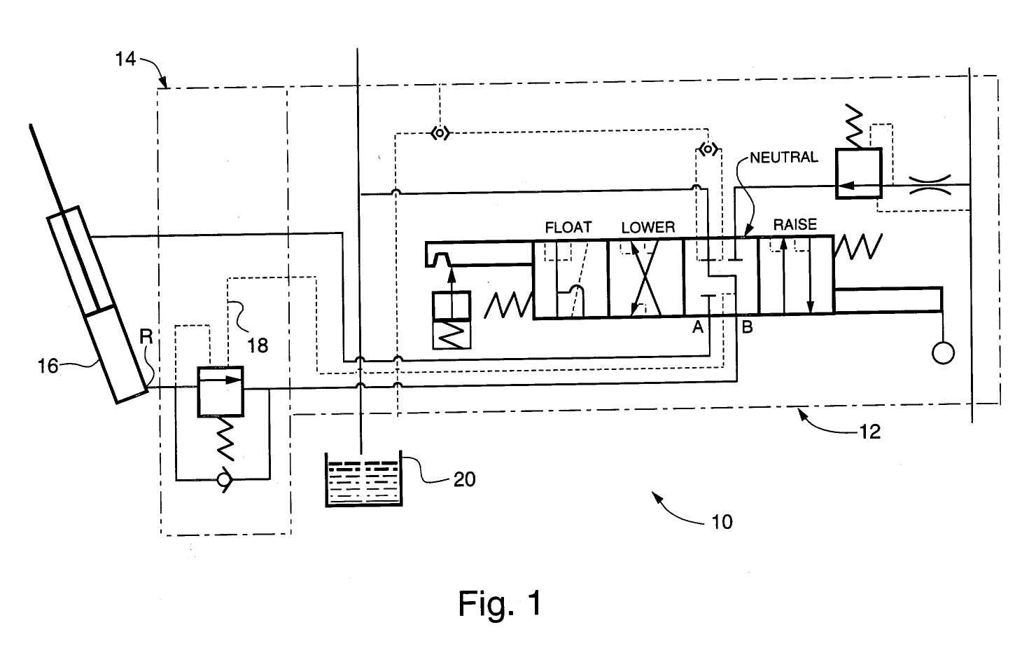

Referring now to FIG. 1, the control valve 10 of the instant invention can be seen to comprise two primary elements: (1) an agricultural remote valve section 12, and (2) a counterbalance valve assembly 14. The operational purpose of these elements is to control the boom loader cylinder 16, i.e., the control of hydraulic fluid flow to raise and lower the boom, or to put it into either a neutral locked status or a float status.

The control valve 10 of the instant invention provides an improved zero leak load holding capability by providing the relief portion 18 of the counterbalance cartridge valve 14. For purposes of illustration, only one cylinder is shown; however, in actual practice there may be two or more cylinders employed. The raise ports of the boom cylinder(s) R are connected to the counterbalance relief valve 18, which is set higher than the lift capacity of the loader. This results in a positive lock of the boom cylinder(s) (no leak down) when the remote valve 12 is in neutral.

As the loader is lowered, the oil pressure at the lower port A of the valve assembly is piloted internally to the relief valve 18, acting against the relief spring in a set ratio (10:1 being preferred) and thereby reducing the relief setting. This reduction in relief pressure allows the boom cylinder(s) 16 to retract, lowering the loader. If the loader drops faster than flow is being provided to the lower ports, the pilot pressure counteracting the relief will drop, causing the relief setting to increase and hold the load back. This provides over-running load control and a stable, smooth lowering of heavy loads at all engine speeds and all lowering rates.

The float function of the control valve involves connecting all of the ports of the boom cylinders to tank allowing the loader to float on the ground surface. This is accomplished by the remote valve assembly 12 providing a pilot pressure (hydraulic system standby pressure) when shifted to the float position. This pilot pressure is fed to the relief valve 18 of the counterbalance valve assembly 14 in the same ratio as above to counteract the relief setting completely allowing free oil flow from the boom cylinder(s) to tank 20.

With the remote valve in the neutral position, the raise port B of the remote valve is open to tank 20 and the relief valve 18 of the counterbalance cartridge assembly 14 holds the cylinder in position. Thus, when an overload condition of the boom cylinder(s) is encountered (carrying a heavy load with loader raised, digging, for example, into a dirt pile) the relief valve 18 will open and allow the boom cylinder(s) 16 to displace. This reduces the potential of the boom cylinder(s) buckling while carrying a heavy load fully raised and improves reliability of components during digging modes by lowering the pressure spikes.

Pilot operated check valves, mounted on the loader assembly, are typically used in zero leak cylinder applications of agricultural loaders; however, to maintain smooth lowering operation, orifices need to be added to limit loader lowering rates thus maintaining a positive lowering pressure which keeps the pilot operated check valve to open during low flow operations. The additional orifices increase lowering times and overall cycle times. The counterbalance valve has excellent meter out characteristics and limits the flow from the cylinder(s) to match the available lowering flow from the remote valve, thereby not requiring orifices to limit lowering rates. This results in much faster duty cycles.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions. Accordingly, the following claims are intended to protect the invention broadly as well as in the specific form shown.

Having thus described the invention, what is claimed is:

1. In an agricultural tractor having a source of pressurized hydraulic fluid, a manually activated control valve in fluid-flow communication with the source of pressurized hydraulic fluid, and a hydraulically controlled loader boom lift circuit, including at least one hydraulic cylinder with a raise port, a lower port, and a ram therebetween, said raise and lower ports in fluid-flow communication with the control valve, the improvement comprising:
said control valve has at least one neutral position, one raise position causing pressurized fluid to flow to said raise port of said at least one hydraulic cylinder to extend said ram, and one lower position causing pressurized fluid to flow to said lower port of said at least one hydraulic cylinder to retract said ram; and
a counterbalance relief valve with a relief pressure setting higher than the lift capacity of said at lest one hydraulic cylinder, said relief valve positioned between said control valve and said raise port when said control valve is in said neutral position, thereby providing a positive, zero leak, lock of said at least one hydraulic cylinder.

2. The improvement of claim 1, wherein:
said control valve causing pressurized fluid flow to said lower port in said at least one hydraulic cylinder when in said lower position;
said relief valve has a relief spring to establish the pressure required to operate said relief valve; and
said control valve, when in said lower position, is piloted internally to said relief valve, causing pressurized fluid to act against said relief spring in a set ratio, to reduce the relief setting, thereby causing said ram to retract.

3. The improvement of claim 2, wherein:
said at least one hydraulic cylinder is connected to a loader that is raised when said control valve is in said raise position and to lowered toward the ground when in said lower position;
said control valve having at least one float position causing said loader to float on the ground;
a reservoir tank on said tractor in fluid-flow communication with said control valve;
said control valve, when in said float position, causes said raise and lower ports to be in fluid-flow communication with said tank, and said control valve is piloted to said relief valve in said set ratio to counterbalance the relief setting of said spring, whereby free fluid flow occurs from said at least one cylinder to said tank.

4. The improvement of claim 3, wherein:
said set ratio is approximately 10:1.

5. The improvement of claim 4, wherein:
said at least one hydraulic cylinder is two hydraulic cylinders.

6. An agricultural tractor loader boom circuit comprising:
a source of pressurized hydraulic fluid;
a manually activated control valve in fluid-flow communication with the source of pressurized hydraulic fluid;
a hydraulically controlled loader boom lift circuit, including at least one hydraulic cylinder with a raise port, a lower port, and a ram therebetween, said raise and lower ports in fluid-flow communication with the control valve;
said control valve having at least one neutral position, one raise position causing pressurized fluid to flow to said raise port of said at least one hydraulic cylinder to extend said ram, and one lower position causing pressurized fluid to flow to said lower port of said at least one hydraulic cylinder to retract said ram; and
a counterbalance relief valve with a relief pressure setting higher than the lift capacity of said at lest one hydraulic cylinder, said relief valve positioned between said control valve and said raise port when said control valve is in said neutral position, thereby providing a positive, zero leak, lock of said at least one hydraulic cylinder.

7. The boom circuit of claim 6, wherein
said control valve causing pressurized fluid flow to said lower port in said at least one hydraulic cylinder when in said lower position;
said relief valve has a relief spring to establish the pressure required to operate said relief valve; and
said control valve, when in said lower position, is piloted internally to said relief valve, causing pressurized fluid to act against said relief spring in a set ratio, to reduce the relief setting, thereby causing said ram to retract.

8. The boom circuit of claim 7, wherein:
said at least one hydraulic cylinder is connected to a loader that is raised when said control valve is in said raise position and to lower toward the ground when in said lower position;
said control valve having at least one float position causing said loader to float on the ground;
a reservoir tank on said tractor in fluid-flow communication with said control valve;
said control valve, when in said float position, causes said raise and lower ports to be in fluid-flow communication with said tank, and said control valve is piloted to said relief valve in said set ratio to counterbalance the relief setting of said spring, whereby free fluid flow occurs from the at least one cylinder to said tank.

9. The improvement of claim 8, wherein:
said set ratio is approximately 10:1.

10. The improvement of claim 9, wherein:
said at least one hydraulic cylinder is two hydraulic cylinders.

11. An agricultural tractor loader boom circuit comprising:
a source of pressurized hydraulic fluid;
a manually activated control valve in fluid-flow communication with the source of pressurized hydraulic fluid;
a hydraulically controlled loader boom lift circuit, including at least two hydraulic cylinders each with a raise port, a lower port, and a ram therebetween, said raise and lower ports in fluid-flow communication with the control valve;
said control valve having at least one neutral position, one raise position causing pressurized fluid to flow to said raise ports of said hydraulic cylinders to extend said rams, and one lower position causing pressurized fluid to flow to said lower ports of said one hydraulic cylinders to retract said rams; and
a counterbalance relief valve with a relief pressure setting higher than the lift capacity of said hydraulic cylinders, said relief valve positioned between said control valve and said raise ports when said control valve is in said neutral position, thereby providing a positive, zero leak, lock of said hydraulic cylinders.

12. The boom circuit of claim 11, wherein
said control valve causing pressurized fluid flow to said lower ports in said hydraulic cylinders when in said lower position;
said relief valve has a relief spring to establish the pressure required to operate said relief valve; and
said control valve, when in said lower position, is piloted internally to said relief valve, causing pressurized fluid to act against said relief spring in a set ratio, to reduce the relief setting, thereby causing said rams to retract.

13. The boom circuit of claim 12, wherein:
said hydraulic cylinders are connected to a loader that is raised when said control valve is in said raise position and lowered toward the ground when in said lower position;
said control valve having at least one float position causing said loader to float on the ground;
a reservoir tank on said tractor in fluid-flow communication with said control valve;
said control valve, when in said float position, causes said raise and lower ports to be in fluid-flow communication with said tank, and said control valve is piloted to said relief valve in said set ratio to counterbalance the relief setting of said spring, whereby free fluid flow occurs from said hydraulic cylinders to said tank.

14. The improvement of claim 13, wherein:
said set ratio is approximately 10:1.
